(19) United States
(12) Patent Application Publication
(10) Pub. No.: US 2023/0315479 A1
(43) Pub. Date: Oct. 5, 2023

(54) METHOD AND SYSTEM FOR SUPPORTING THROUGHPUT-ORIENTED COMPUTING

(71) Applicant: NEC LABORATORIES EUROPE GMBH, Heidelberg (DE)

(72) Inventor: Daniel THUERCK, Heidelberg (DE)

(21) Appl. No.: 18/023,755

(22) PCT Filed: Feb. 25, 2021
(86) PCT No.: PCT/EP2021/054748

§ 371 Date: Feb. 28, 2023

(30) Foreign Application Priority Data
Sep. 10, 2020 (EP) 20195570.5

(51) Int. Cl. G06F 9/38; G06F 15/78; G06F 9/30

(52) U.S. Cl. CPC G06F 9/3887; G06F 15/78; G06F 9/30101

(57) ABSTRACT

A method for supporting throughput-oriented computing includes a single instruction multiple threads (SIMT) program configured to launch a plurality of warps, each respective warp of the plurality of warps comprises threads to be executed in lockstep within the each respective warp. Individual warp sizes of the plurality of warps are used as a runtime parameter for the SIMT program, such that a parameterized SIMT program is provided, which is parameterizable via the individual warp sizes, and the parameterized SIMT program is executed on a single instruction multiple data (SIMD) vector architecture.

### CROSS REFERENCE TO RELATED APPLICATIONS

This application is a U.S. National Phase application under 35 U.S.C. § 371 of International Application No. PCT/EP2021/054748, filed on Feb. 25, 2021, and claims benefit to European Patent Application No. EP 20195570.5, filed on Sep. 10, 2020. The International Application was published in English on Mar. 17, 2022 as WO 2022/053183 A1 under PCT Article 21(2).

### FIELD

The present invention relates to a method for supporting throughput-oriented computing, in particular in a high-performance computing system.

Furthermore, the present invention relates to a system for supporting throughput-oriented computing.

### BACKGROUND

The last decade has seen a massive increase in raw compute power due to the inclusion of graphics processing units (GPUs) in high-performance computing (HPC) systems. GPUs augment the previously dominant multi-core CPU (central processing unit) setups by adding the option to effectively perform throughput-oriented computing (TOC). The non-patent literature of M. Garland and D. B. Kirk, “Understanding throughput-oriented architectures”, Communications of the ACM, 53(11):58-66, 2010 mentions three important design principles for such systems: an abundance of rather simple processing units, SIMD-style execution and hardware multithreading. In this spirit, the scheduling hardware on GPUs is kept simple in favor of including more local memory and execution units.

NVIDIA's GPUs are primarily accessed by the native CUDA API, implementing a 2-level, regular grid of work items of constant size as its native programming model. The effective use of the hardware mandates an abundance of work items, outnumbering the available hardware compute units by far. Work items that are actively being computed by the compute units in a given moment may be also designated as threads in this context. On such GPUs, 32 work items/threads are jointly executed in SIMT style inside a so-called warp, with multiple fixed-size warps sharing a shared multiprocessor (SM) in order to hide latencies. Consequently, architectures implementing the TOC principles perform poorly when encountering control flow irregularity (e.g. branch divergence, fine-grained synchronization) or data irregularity (e.g. differing resource requirements between work items/threads).

Opposed to that, modern multi-core CPUs are optimized for latency and can use out-of-order execution to reorder instructions and speculative execution to combat control flow irregularity. Furthermore, they support simultaneous multithreading (SMT) to swap between executing applications, albeit at much higher cost than hardware multithreading in GPUs. Similarly, all their CPU cores are independent and request resources as needed. The concepts of latency and throughput-oriented architectures are diametrical opposites.

Accordingly, the last decade has seen continued exponential performance increases in HPC systems, well after the predicted end of Moore's Law for CPUs, however, largely due to the widespread adoption of throughput-oriented compute accelerators such as GPUs. When faced with irregular yet throughput-oriented applications, their simple, grid-based computing model turns into a serious limitation. Indeed, classical domains where TOC proves effective are now facing the increasing use of irregular applications: e.g., sparse matrices, graph neural networks and sum-product networks. Sparse matrices are the bedrock to modern applications in computing science and the machine learning community has recently started to adopt new and irregular architectures such as graph neural networks and sum-product networks.

The architectural continuum between throughput-oriented SIMT/SIMD designs and latency-based (e.g. SMT) designs has been explored to great depths. Multiple extensions to SIMT designs have been proposed: Scalar co-processors for GPU cores that avoid repeated scalar computations; central schedulers share the GPU between host threads or dynamic re-grouping of threads from a warp or block into convergent subgroups. Similar to SMT context switches, the non-patent literature of S. Frey, G. Reina, and T. Ertl.: “SIMT Microscheduling: Reducing Thread Stalling in Divergent Iterative Algorithms”, In PDP′20 propose a model for oversubscription of tasks to SIMT cores and a method for faster context switches using the cores' L1 cache. Similarly, work-stealing between warps has been explored. On the other end of the spectrum, multiple works have investigated layering a SIMT scheduler on top of arrays of in-order CPU cores. These arrays switch between MIMD mode (each processor operates independently) and SIMT mode (control logic is shared by all processors) to save power. Subsequent works extend this idea into a form of “hardware auto-vectorization” of scalar code. In order to group similar instructions on cores of the array, expensive crossbars are required.

Liquid SIMD (cf. non-patent literature of N. Clark, A. Hormati, S. Yehia, S. Mahlke, and K. Flautner, Liquid SIMD: “Abstracting SIMD hardware using lightweight dynamic mapping”, In HPCA′ 07) and Vapour SIMD (cf. non-patent literature of D. Nuzman, S. Dyshel, E. Rohou, I. Rosen, K. Williams, D. Yuste, A. Cohen, and A. Zaks, “Vapor SIMD: Auto-vectorize once, run Everywhere”, In CGO′ 11) on the software side and ARM's SVE hardware extensions (cf. non-patent literature of A. Armej ach, H. Caminal, J. M. Cebrian, R. González-Alberquilla, C. Adeniyi-Jones, M. Valero, M. Casas, and M. Moretó, “Stencil codes on a vector length agnostic architecture”, In PACT′ 18) improve SIMD systems for irregular applications: they offer a convenient way to set the SIMD vector length at runtime, adapting to tasks with varying resource requirements.

### SUMMARY

In an embodiment, the present disclosure provides a method for supporting throughput-oriented computing. The method includes a single instruction multiple threads (SIMT) program configured to launch a plurality of warps, each respective warp of the plurality of warps comprises threads to be executed in lockstep within the each respective warp, wherein individual warp sizes of the plurality of warps are used as a runtime parameter for the SIMT program, such that a parameterized SIMT program is provided, which is parameterizable via the individual warp sizes, and wherein the parameterized SIMT program is executed on a single instruction multiple data (SIMD) vector architecture.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a code example illustrating a compilation pass from CUDA to vector-ready PTX for a method in accordance with embodiments of the invention, wherein a sparse matrix-vector multiplication (SpMV) kernel is used;

FIG. 2 is a schematic view illustrating an example of distributing warps to SIMD vector cores in accordance with embodiments of the invention;

FIG. 3 is a schematic view illustrating a register renaming process in accordance with embodiments of the invention;

FIG. 4 is a schematic view illustrating an architecture overview of NEC's SX-Aurora TSUBASA;

FIG. 5 is a schematic view illustrating an architecture overview of a vector core for a system in accordance with embodiments of the invention;

FIG. 6 is a schematic view illustrating a method in accordance with an embodiment of the present invention;

FIG. 7 is a schematic view illustrating a process of metadata register programming for processing warps and partitioning of multiple warps into a single partition;

FIG. 8 is a schematic diagram illustrating simulation results from a model-driven simulation of a setup in accordance with an embodiment of the invention;

FIG. 9 is a schematic diagram illustrating further simulation results from a model-driven simulation of a setup in accordance with an embodiment of the invention; and

FIG. 10 is a schematic diagram illustrating further simulation results from a model-driven simulation of a setup in accordance with an embodiment of the invention.

### DETAILED DESCRIPTION

In an embodiment, the present invention improves and further develops a method and a system of the initially described type for supporting throughput-oriented computing in such a way that handling irregularity, in particular data and/or control flow irregularity, on throughput-oriented processors is improved.

In another embodiment, the present invention provides a method for supporting throughput-oriented computing, in particular in a high-performance computing system, wherein a single instruction multiple threads (SIMT) program is configured to launch warps, wherein each warp comprises threads to be executed in lockstep within their warp, wherein the warps' individual warp sizes are used as a runtime parameter for the SIMT program, such that a parameterized SIMT program is provided, which is parameterizable via the warp sizes, and wherein the parameterized SIMT program is executed on a single instruction multiple data (SIMD) vector architecture.

In another embodiment, the present invention provides a system for supporting throughput-oriented computing, the system comprising a programming model and a SIMD vector architecture, wherein the programming model is configured to provide a SIMT program for launching warps, wherein each warp comprises threads to be executed in lockstep within their warp, and to use the warps' individual warp sizes as a runtime parameter for the SIMT program, such that a parameterized SIMT program is provided, which is parameterizable via the warp sizes, and wherein the SIMD vector architecture is configured to execute the parameterized SIMT program.

According to the invention it has first been recognized that when faced with irregular yet throughput-oriented applications, a simple grid-based computing model of throughput-oriented compute accelerators such as GPUs turns into a serious limitation. Instead of repeatedly tackling the issues of irregularity on the application layer, it has been further recognized that a generalization of a SIMT (single instruction multiple threads) model (such as the CUDA model) to irregular grids can be supported through modifications to already established throughput-oriented architectures. To that end, is has been implemented a unifying approach—adhering to the SIMT principles—based on an unlikely ally: a SIMD vector architecture. Consequently, a SIMT program is configured to launch warps, wherein each warp comprises a package of threads to be executed in lockstep within their warp. Thus, the threads inside a warp are operating in lockstep. According to the invention, the warps' individual warp sizes are used as a runtime parameter for the SIMT program, such that a parameterized SIMT program is provided, which is parameterizable via the warp sizes. By doing this, the warps are directly exposed to users. The parameterized SIMT program is executed on a single instruction multiple data (SIMD) vector architecture.

Thus, the present invention provides a method and a system for supporting throughput-oriented computing, wherein handling of irregularity, in particular data and/or control flow irregularity, on throughput-oriented processors is improved.

The term “SIMD architecture” may be understood, in particular in the claims, preferably in the description as a term applied to architectures that execute a single instruction on multiple data items simultaneously. For instance, a corresponding definition is given in the non-patent literature of Flynn, Michael J, “Some Computer Organizations and Their Effectiveness”, IEEE Transactions on Computers C-21(9): 948-960, 1972. Modern CPUs may implement this principle in the form of vector registers, containing multiple scalar values in a single (hardware) vector register. For example, in Intel's AVX extension, usual sizes are 8 to 16 scalars contained in a single hardware vector register. Vector registers comprising far more than this number of scalar values may be designated as wide-SIMD. Thus, for example, a wide-SIMD architecture may have at least 32 scalars. An example is NEC's Aurora architecture with 256 scalars. Each scalar slot of a vector register may be referred to as a lane.

However, a SIMT architecture considers each lane of a SIMD registers as a separate program, designated as a thread. It builds hardware support for potential divergent execution within a SIMD register through masking out single lanes. Furthermore, the resulting latencies are hidden through hardware multithreading. In NVIDIA's SIMT architectures, 32 threads are simultaneously executed in lockstep as a warp.

According to embodiments of the invention, a programming model may be provided, wherein the programming model is based on a SIMT programming model, in particular based on the CUDA programming model. The programming model may be extended for handling data irregularity by having a user input a list of warp sizes. Traditionally, CUDA kernels are parameterized over a grid of blocks, e.g.
kernel<<<m, n>>>( . . . );

which launches m blocks with n threads each. On the hardware, each block is scheduled onto a streaming multiprocessor (SM). However, the block abstraction of the CUDA programming model hides the underlying execution model: Inside a block, threads are executed in packages on 32, which may be designated as warps. All threads in a warp operate in lockstep and branches or conditionals are implemented by predicating the execution in some threads; this corresponds to the SIMT model as mentioned above. In recent GPU architectures, all threads in a warp access the same partition in the streaming multiprocessor's (SM's) register file and communicate through it with low-latency. Blocks of variable sizes mᵢ can only be emulated by setting the block size to m=max{mᵢ}ᵢ and masking out threads in each block. According to embodiments of the invention, it has been gotten rid of the block abstraction and directly exposed warps to users. In order to handle data irregularity, the individual warps' sizes have been made a runtime parameter. Hence, instead of passing parameters m, n to the kernel, this may require passing an explicit list of warp sizes:
const int w_list[ ]={4, 11, 3, 2, 8, 31;
kernel<<<m, w_list>>>( . . . );

According to embodiments of the invention, it may be provided that the warps are distributed to SIMD vector cores of the SIMD vector architecture. Advantageously, it may be provided that the warps are distributed by a round-robin method to the SIMD vector cores of the SIMD vector architecture. Thus, a fair distribution of the warps over the vector cores can be achieved.

According to embodiments of the invention, the SIMT program may be mapped onto SIMD vector registers of the SIMD vector architecture by using predetermined (explicit) vector registers of the SIMD vector architecture. The predetermined vector registers are initialized by SIMT metadata of SIMT metadata registers. Thus, explicit (hardware) vector registers are used to have a link to the SIMT metadata. Hence, a method can be provided to execute scalable SIMT code with minimal modifications in different runtime configurations on SIMD processors, i.e. SIMD vector cores, using the metadata registers.

The term “metadata” may be understood, in particular in the claims, preferably in the description as parameters that identify a thread. Thus, metadata may comprise parameters that identify a thread in the SIMT context. Hence, e.g., the index of the work item/thread within the global grid may be considered as metadata. In SIMT architectures, each thread stores this metadata, which is stored and handled by the warp scheduler managing the hardware multithreading. According to embodiments of the invention, this metadata may be stored in pre-determined SIMD vector registers instead. Thus, each kind of metadata may be mapped onto one vector register, wherein each lane represents one thread (work item) and the mapping between a thread inside a SIMT warp and lane in the metadata register is fixed.

According to embodiments of the invention, the SIMT metadata may include a thread index information, a warp index information and/or a warp size information. Thus, thread indices, warp indices and/or warp sizes can be used in order to handle data irregularity, wherein an execution of SIMT code on SIMD architectures is enabled by concatenating threads' registers into SIMD registers.

According to embodiments of the invention, a mapping of the threads' SIMT metadata registers to lanes in SIMD vector registers of the SIMD vector architecture may be performed at runtime of the SIMT program. Thus, it is followed a SIMT-on-SIMD paradigm by mapping the corresponding registers of threads in a warp to lanes in SIMD registers. Rather than at compile time, that mapping is performed on runtime. Thus, the handling of data irregularity can be achieved efficiently.

According to embodiments of the invention, the SIMT program may be compiled to an intermediate code representation, wherein the intermediate code representation is configured to replace one or more identifiers pertaining to the SIMT program's runtime configuration with references to SIMT metadata registers. The SIMT execution can be emulated by explicitly associating keywords (such as tid for a thread's index) in metadata registers to each lane, such that a parameterized SIMD execution is provided. Appearances of those keywords in the code can be then translated to registers with suitable execution. Unless there is branching involved, SIMT code can translate 1:1 into SIMD code. A predicated instruction can be realized through masks over SIMD vector registers. For architectures that support setting a vector length (vl) at runtime, a scalar metadata register may be added. Such architectures, commonly called “vector processors”, operate on vector registers in a way such that the latency of an instruction is determined by the number of scalar date items in its vector registers. The latter is set as vl, thus resulting in shorter runtimes where parts of vector register are not filled with data.

Due to the lack of per-thread program counters (PCs), SIMD hardware is unable to track execution paths of different threads. Instead, all threads follow the same path of execution. Inactive threads' lanes are masked out in accordance with an embodiment of the invention. In order to simulate this behavior, a compiler may carry out two steps: first, whenever branching (through e.g. loops) is involved, create a predicate indicating whether a thread took the branch or not. The resulting predicate is then applied to all instructions that can potentially follow. If additional predicates appear, they should be combined via and. Additionally, a loop may be repeated unless its condition evaluates to false for all threads in a warp. Thus, according to embodiments, warp-synchronous branching commands may be provided, which only branch if all threads in the warp agree on a predicate's result.

According to embodiments of the invention, the intermediate code representation may include a scalar branch control such that warp-synchronous branching commands are provided that only branch if all threads in the warp agree on a predicate's result.

According to embodiments of the invention, a predicate may be created whenever branching is involved in the SIMT program. The predicate indicates whether a thread took a branch or not, wherein the predicate's result is applied to all instructions that can (potentially) follow implicitly without further annotation. Thus, the predicate's result can be applied automatically to the instructions.

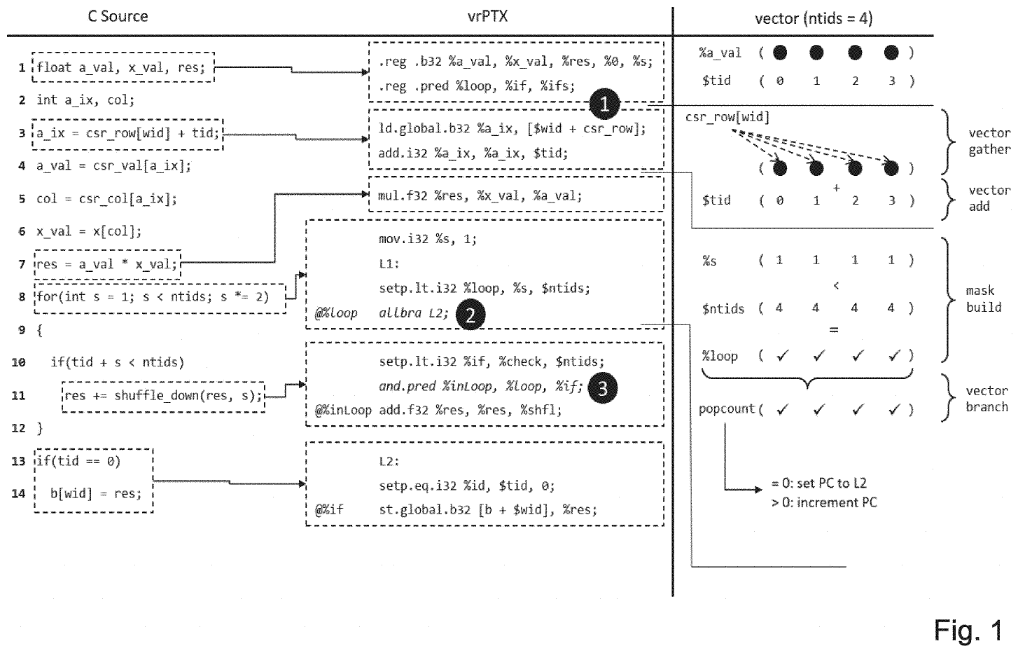

According to embodiments of the invention, a control flow of the SIMT program may be modified to emulate branching by using a stack of masks for SIMD vector registers, wherein a translation from thread-wide branching instructions to warp-wide branching instructions is provided. Furthermore, it may be provided that whenever a branching instruction is encountered, the corresponding predicate is evaluated and the branch is taken only if all of the involved threads evaluate the predicate to false (cf., e.g., an “allbra” instruction as illustrated in FIG. 1 at (2)).

According to embodiments of the invention, it may be provided that a partitioning scheme is implemented for executing multiple partitions on a SIMD vector core of the SIMD vector architecture, wherein a partition includes one or more warps to be executed on the SIMD vector core.

According to embodiments of the invention, several warps included in a partition may be packed into a single SIMD vector register by concatenating their metadata, wherein a vector length of the SIMD vector register is increased accordingly. Thus, an active vector length management is performed.

According to embodiments of the invention, a register renaming may be performed inside SIMD vector cores of the SIMD vector architecture in order to multiplex instruction streams from multiple partitions into a joint vector instruction buffer. Thus, each SIMD vector core can have one vector instruction buffer.

According to embodiments of the invention, the register renaming may be performed based on a reprogrammable partitioned register table.

Further features, advantages and further embodiments are described and may be become apparent in the following:

In order to bring the success and simplicity of CUDA's programming models to applications dealing with data and/or control flow irregularities, a method and a system in accordance with embodiments of the invention provide an extension that models the applications' inherent data irregularity. In keeping with the SIMT spirit, arising issues can then be solved with minimal hardware involvement. In fact, embodiments of the invention can show that the classic architecture of vector computers (which may be designated as SIMD computers or “wide-SIMD” computers) such as NEC's SX-Aurora TSUBASA have all the components that a design in accordance with an embodiment of the invention. Thus, a modified vector architecture is proposed that exploits the on-chip register renaming unit to support both SMT and SIMT execution efficiently on one (wide-) SIMD chip. As a result, a design in accordance with an embodiment sets itself apart from others by offering both a simple programming model and incremental (and thus, quickly realizable) hardware modifications that are consistently designed around the support for irregular applications.

According to embodiments of the invention, CUDA's PTX ISA may be extended to support an irregular compute model. The compute model can be mapped to wide-SIMD processors in order to handle data irregularity.

According to embodiments of the invention, it may be provided that register renaming is used as a tool to emulate SIMT-like hardware multithreading on a simple vector core, avoiding costly context switches, such that a handling of control flow irregularity is achieved.

According to embodiments of the invention, approaches for handling data irregularity and for handling control flow irregularity may be integrated into a modified SX-Aurora architecture.

Embodiments of the invention extend the commonly used, regular computing model in the area of throughout-oriented computing to tasks that exhibit data and control flow irregularity (which may be referred to as “irregular tasks”). Embodiments of the invention offer ways to combine and map instances of throughput-oriented programs (“kernels”) to a conventional, regular wide-SIMD processor.

By combining the techniques outlined above, embodiments of the present invention may require only minor, incremental modifications to existing hardware designs in order to extend their capabilities to irregular computing. Thus, the invention adheres to the principles of throughput oriented execution and SIMT execution while integrating some techniques from the (orthogonal) concept of latency-based computing to utilize the underlying hardware as much as possible. This guarantees simple inclusion into existing, well-supported HPC stacks and widespread adoption in the community.

At the same time, embodiments of the invention allow the use of a simple, batched programming model that operates on the same principle as SIMT kernels do; kernel developers do not need to acquire a new skill when using hardware modified according to principles in accordance with embodiments of the invention.

Embodiments of the invention may be purely targeted at processors and kernels on throughput-oriented systems. Modifications in accordance with an embodiment of the invention do not turn wide-SIMD systems into performant general-purpose systems. Accordingly, it may be provided that the limitations from throughput-oriented systems such as GPUs are inherited: best performance is only reached for well-parallelized code with high arithmetic intensity, low memory intensity and ideally, only a limited amount of branching.
As NEC's SX Aurora Tsubasa product is an example of a wide-SIMD card, the proposed modifications can immediately be implemented there, preparing it for more irregular throughput-oriented applications that are currently popping up (such as graph neural networks in machine learning).
The simple programming interface and SIMT-to-SIMD conversion can largely be implemented in software, including for regular programs. Techniques from embodiments of the invention may be included into NEC's NCC compiler in order to port CUDA code to Aurora. After the hardware changes, NEC's Aurora can be a HPC accelerator to offer native support for SIMD, SIMT and SMT principles.

Hence, embodiments of the present invention relate to methods and systems to modify wide-SIMD HPC accelerators (e.g., but not exclusively, NEC's SX-Aurora Tsubasa) in order to improve execution of irregular throughput-oriented programs. Embodiments may propose an integrated system of compiler extensions and modifications to hardware components that result in low-overhead methods for scheduling irregular applications using a simple interface. Embodiments of the invention offer a path towards bridging the gap between throughout oriented computing and the demands of irregular applications by incremental changes to existing solutions.

Embodiments of the invention may describe a method for processing parameterized SIMT programs suffering from data and control flow irregularity efficiently on SIMD hardware with minimal hardware changes using an integrated system of programming model, compiler extension and re-purposing of existing hardware. The method offers ways of merging differently parameterized programs into a single instruction stream in order to fully utilize the underlying hardware.

There are several ways how to design and further develop the teaching of the present invention in an advantageous way. To this end it is to be referred to the patent claims subordinate to patent claim 1 on the one hand and to the following explanation of further embodiments of the invention by way of example, illustrated by the figure on the other hand. In connection with the explanation of the further embodiments of the invention by the aid of the figure, generally further embodiments and further developments of the teaching will be explained.

FIG. 1 shows a code example illustrating a compilation pass from CUDA to vector-ready PTX for a method in accordance with embodiments of the invention, wherein a sparse matrix-vector multiplication (SpMV) kernel is used. According to the embodiment as illustrated by FIG. 1, a solution is provided that integrates a modified compilation pass from CUDA (cf. C source code on the left side of FIG. 1) to vector-ready PTX (cf. the middle of FIG. 1), an extended version of NVIDIA's PTX that enables execution of SIMT code on SIMD architectures by concatenating threads' registers into SIMD registers. To that end, (1) special registers for warp and thread indices are added, (2) thread-individual branch statements are interpreted as to voting functions over the whole warp and (3) a stack of masks for SIMD registers inside a loop is maintained. On the right side of FIG. 1, a corresponding exemplary process is illustrated for a warp having four threads.

### Programming Model of an Embodiment

According to embodiments of the invention, a programming model can be employed, which is based on a SIMT programming model. To that end, a generalization of CUDA's grid-based compute model to irregular workloads is proposed. Traditionally, the CUDA kernels are parameterized over a grid of blocks, e.g.

kernel<<<m, n>>>( . . . );

which launches m blocks with n threads each. On the hardware, each block is scheduled onto a streaming multiprocessor (SM). However, the block abstraction hides the underlying execution model: Inside a block, threads are executed in packages on 32, which can be designated as warps. All threads in a warp operate in lockstep and branches or conditionals are implemented by predicating the execution in some threads; this is commonly referred to as the SIMT model. With thread-independent scheduling having been introduced in the Pascal microarchitecture, the lockstep model has been somewhat relaxed. Each thread now has its own program counter (PC), which allows the warp scheduler to interleave instructions from different of its threads instead of maintaining subgroups within the thread and a stack.

In recent GPU architectures, all threads in a warp access the same partition in the SM's register file and communicate through it with low-latency. Blocks of variable sizes mi can only be emulated by setting the block size to m=max{mi}i and masking out threads in each block. A programming model according to embodiments of the invention is proposed on this issue: First, it is gotten rid of the block abstraction and warps are directly exposed to users. In order to handle data irregularity, the individual warps' sizes are made a runtime parameter. Instead of passing parameters m, n to the kernel, this may require passing an explicit list of warp sizes:

const int w_list[ ]={4, 11, 3, 2, 8, 3};
kernel<<<m, w_list>>>( . . . );

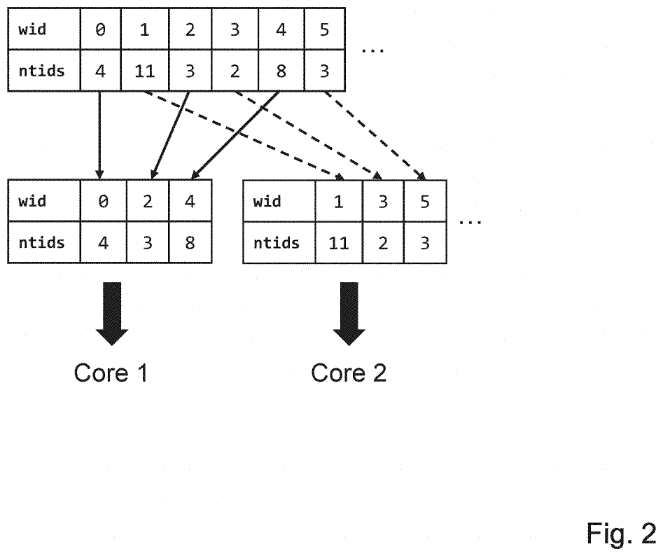

As on GPUs, warps are assigned statically to SMs (SIMT-to-SIMD: vector cores) as illustrated by the example of FIG. 2. FIG. 2 shows a schematic view illustrating an example of distributing warps to SIMD vector cores in accordance with embodiments of the invention. The regular CUDA programming model is extended to irregular execution by having the user input a list of warp sizes, wherein the corresponding (independent) warps are then distributed by a round-robin method to vector cores.

Implementing kernels using CUDA-C follows the same principle as for warp-centric models: all threads in a warp execute the code in a bulk-synchronous manner and threads share data and communicate through shuffle instructions. To distinguish code for a model according to an embodiment of the invention from traditional CUDA code, keywords for a thread's index (such as tid) in a warp and for a warp's index (such as wid) and size (such as ntids) are used.

As a posterchild example, the SpMV-kernel given in FIG. 1 (left) is used, in which each warp handles one row of a sparse CSR matrix (arrays csr_row, csr_col, csr_val). Therein, each thread handles one nonzero entry in the row and the results are accumulated by a warp-wide logarithmic reduction (lines 8 through 12 of C source example on the left side of FIG. 1). This simple kernel exhibits both data and control flow irregularity: First, each warp uses a varying amount of threads and thus the share of the SM's register file depends on a runtime parameter where the classical CUDA execution model may require the register count at compiler time. Second, the number of reduction steps depends on the warp size as well, leading to different execution paths for warps of different sizes. Current GPU schedulers would mandate mi≤32, leading to a potential waste of resources.

### Implementation of an Embodiment

In order to natively support varying warp sizes, embodiments of the invention may take the unconventional step of executing programs in a SIMT-focused programming model on traditional SIMD hardware; specifically, according to embodiments, it may be considered to use wide-SIMD (i.e. vector) hardware. A system in accordance with embodiments of the invention may introduce additions to CUDA's C-to-PTX compiler and modifications to vector instruction buffer and register renaming units in hardware. Both components are frequently found in SIMD microarchitectures (e.g. Intel CPUs with AVX). A fundamental idea of embodiments in accordance with the invention is to translate SIMT code (with SIMD-friendly additions) into SIMD code in hardware and use register naming tables to batch the execution of multiple warps of varying size together.

### A. Front-End:

Executing SIMT code efficiently may require hardware support for predicated execution and branch—as well as reconvergence handling (e.g. through stacks per thread). In SIMT models, each thread inside a warp executes the same (scalar) code, but is parameterized by its index inside the warp (CUDA: lane_id). SIMD code, on the other hand, has no data or stack per lane, and can only operate on whole vectors. Thus, embodiments in accordance with the invention propose several additions to CUDA's virtual PTX code in order to make it more SIMD-friendly, simplifying processing in the back-end. Such changes are visualized using the SpMV example in FIG. 1.

Metadata registers: Embodiments of the invention may follow the SIMT-on-SIMD paradigm of ISPC (cf. the non-patent literature of M. Pharr and W. R. Mark. “ispc: A SPMD compiler for high-performance CPU programming”, In Inpar'12) by mapping the corresponding registers of threads in a warp to lanes in SIMD registers. Rather than at compile time, that mapping is performed on runtime. In this regard, it is noted that the SIMT execution is emulated by explicitly associating keywords such as tid in metadata registers to each lane (parameterized SIMD execution). Appearances of those keywords in the code are then translated to registers with suitable execution, as marked by (1) in FIG. 1. Unless there is branching involved, SIMT code translates 1:1 into SIMD code; predicated instruction are realized through masks over SIMD registers. Furthermore, for architectures that support setting a vector length (vl) at runtime, a (scalar) metadata register is added.

Scalar branch control: Due to the lack of per-thread program counters (PCs), SIMD hardware is unable to track execution paths of different threads. Instead, all threads follow the same path of execution. Loops in high-level languages, e.g., for-loops in C, may be repeated until all threads inside a warp evaluate the loop's condition to false. Inactive threads' lanes, i.e., threads that evaluate the loop's condition to false, are masked out. In order to implement this behavior in accordance with embodiments of the invention, during execution of the program, the loop's condition is then applied as a predicate to all instructions that can potentially follow. Alternatively, if the hardware lacks support for automatic predication, the compiler can combine this predicate (e.g., % inLoop as indicated by (3) of FIG. 1) via and with all other predicates within the loop to emulate this behavior. Second, a loop is may be required to be repeated unless its condition evaluates to false for all threads in a warp—thus, embodiments of the invention propose warp-synchronous branching commands that only branch if all threads in the warp agree on a predicate's result (as indicated by (2) in FIG. 1 as “allbra”). In the following, it is referred to PTX (Parallel Thread Execution) code with these two additions as vector-ready PTX (vrPTX).

The execution resulting in the compiler's transformations as described above, is, in part, specified for a warp of size 4 (ntids=4) in the third column of FIG. 1. Corresponding to line 8 in the C code and (2) in the vrPTX, the predicate % loop is computed by comparing % s and $ntids (“mask build” where “mask” and “predicate” are interchangeable). Through a popcount, it is counted how many threads evaluated % loop to true. Following the concepts from above, until all threads evaluate the predicate to false, the branch in the allbra instruction is not taken. This ensures repeated execution of the for-loop. When all threads evaluate the predicate to false, the program counter is set to L2, continuing the execution of all threads after the loop.

### B. Back-End:

Thanks to parameterized SIMD execution, differently-sized warps all execute the same vrPTX code. Nevertheless, executing each warp on its own SIMD core would often underutilize the hardware and may prevent from hiding latencies, one of the bedrocks of TOC. As a relief, embodiments of the invention propose modifications to hardware in SIMD systems as follows:

Partitioning: Wide-SIMD systems such as NEC's SX-Aurora processor may offer 16,384 bit wide registers. Following execution models, executing a single warp of size less than 512 would leave many SIMD lanes unoccupied. As noted above, SIMT-like execution can be achieved on SIMD registers by providing the appropriate metadata. According to embodiments of the invention, this fact can be used to pack multiple warps and the warps' data into the same SIMD registers, increasing the vector length vl as needed, wherein to the packed warps is referred as one partition. After warp-wide branching instructions are extended to the whole partition, each instruction can be automatically applied to all warps in a partition; however, the partition's runtime is bound by its longest-running warp due to scalar branch control. In order to avoid heavy partition divergence, an embodiment of the invention propose the following: in the compile phase, the vrPTX source is unrolled for multiple values of ntids and the resulting number of instructions is counted. The possible values of ntids may be then grouped into buckets according to the difference in their number of instructions; warps that fall into the same bucket may be put into the same partition. According to embodiments of the invention, it may be provided that each partition only may require one program counter (PC) and one slot in the instruction fetch unit.

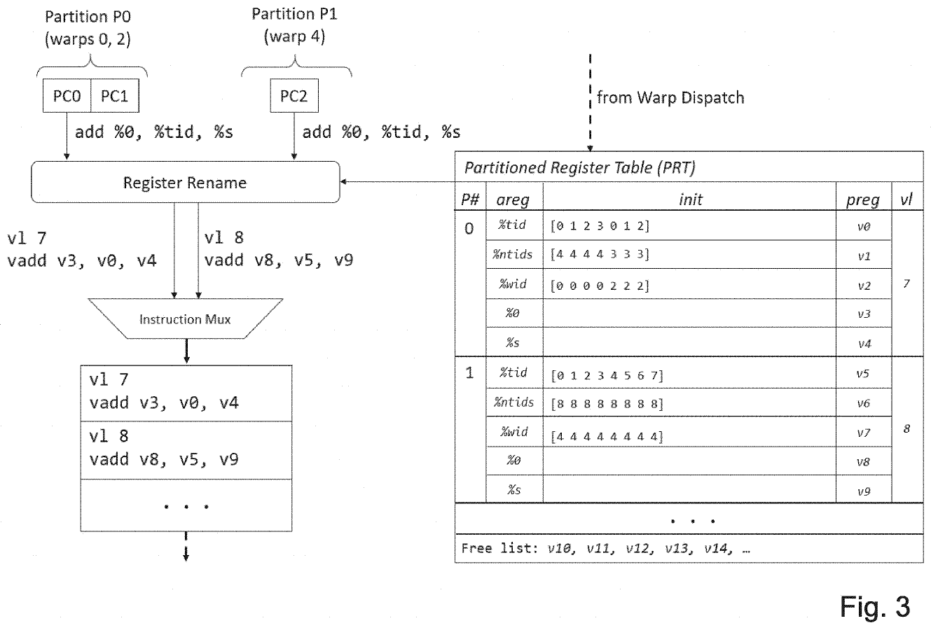

Vector code issue and multiplexing: While partitioning can be advantageous with warps of similar sizes, there may be still need for an approach of handling warps of drastically different sizes. Even though many SIMD cores offer simultaneous multithreading (SMT), wrapping warps into SMT threads is not an option: with larger SIMD registers, SMT context switches become prohibitively expensive. Instead, according to embodiments of the invention, a static partition multiplex scheme is provided that uses a register rename unit to execute multiple partitions at once. This approach is illustrated by FIG. 3, which shows a schematic view illustrating a register renaming process in accordance with embodiments of the invention. Inside vector cores, a register renaming unit is used to multiplex instruction streams from multiple warps into one vector instruction buffer. Thus, the register renaming unit is employed to multiplex vrPTX instruction streams from multiple warps into one single stream of vector instructions.

As long as vector length vl is less than the number of SIMD lanes, all partitions may require the same number of SIMD registers. Hence, the process may be implemented analogous to SIMT processors and the register file is divided according to the partitions. In the embodiment of FIG. 3, partition 0 (packing warps 0 and 2) uses physical SIMD registers v0 through v4, partition 1 with warp 4 uses physical SIMD registers v5 through v9. Using the partitioned register table (PRT), incoming vrPTX instructions can be mapped to conflict-free physical SIMD registers. After the mapping, a lookup table performs 1:1 translation from vrPTX to SIDM vector instructions and sets the runtime vl accordingly. After renaming, the resulting vector instructions are collected in a buffer. Since there are no dependencies between instruction streams from different partitions, the ability of many SIMD systems may be used to process instructions out-of-order (OoO) to hide latencies by picking other partitions' instructions from the buffer. At this point, all vector instructions are treated equally, without any information about the partition they originated in. Whenever a partition finishes its execution, associated SIMD registers are put back into the PRT's free list; next, the warp dispatcher greedily reads from its assigned warps (as indicated by FIG. 2), builds partitions as needed and continues execution.

According to embodiments of the invention, SMT capabilities can be used to build virtual cores that map to the same physical core in order to hide latencies between sets of partitions. Hence, all partitions on a core can benefit from the shared instruction cache depending on their PCs and the kernel code length. Furthermore, every SIMD-capable hardware that includes both an OoO instruction buffer and a register may be eligible for a design in accordance with embodiments of the invention.

C. Integration into Sx-Aurora:

As a practical example, the modification of a vector processor design that is already on the market is considered: NEC's SX-Aurora TSUBASA.

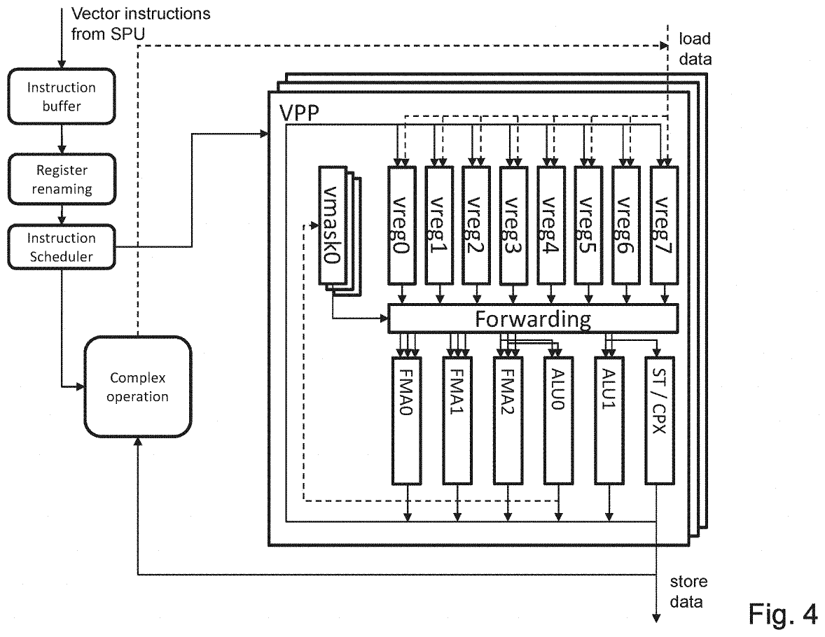

FIG. 4 shows the architecture of SX-Aurora's VPU. Up to 1 vector instruction is issued by the SPU in each cycle, going into the vector instruction buffer. Out-of-order execution is enabled by a rudimentary register renaming unit that solves read-after-write and write-after-write conflicts. Instructions are issued into 32 vector processing pipelines (VPPs) with 8 vector registers and 3 execution ports each.

Aurora's models 20x are PCIe cards that offers up to 10 cores running at 1.6 GHz, achieving up to 3.07 TFLOPs in double precision mode. All cores share 16 MB last-level cache (LLC), interfacing with 48 GB of HBM2 memory with a sustained bandwidth of 1.53 TB/s. Each Aurora core features a relatively simple, out-of-order scalar processor (SPU) that can issue one instruction per cycle to the core's vector processing unit (VPU) as illustrated by FIG. 4. Each VPU uses register renaming to resolve WAW and WAR dependencies and reorders vector instructions before issuing them to the 32 vector processing pipelines (VPP) per core. VPPs, in turn, each include 8 vector registers with 16,384 bit, 2 mask registers and 3 execution ports to FMA units and ALUs (only 64 architectural vector registers are exposed through the ISA).

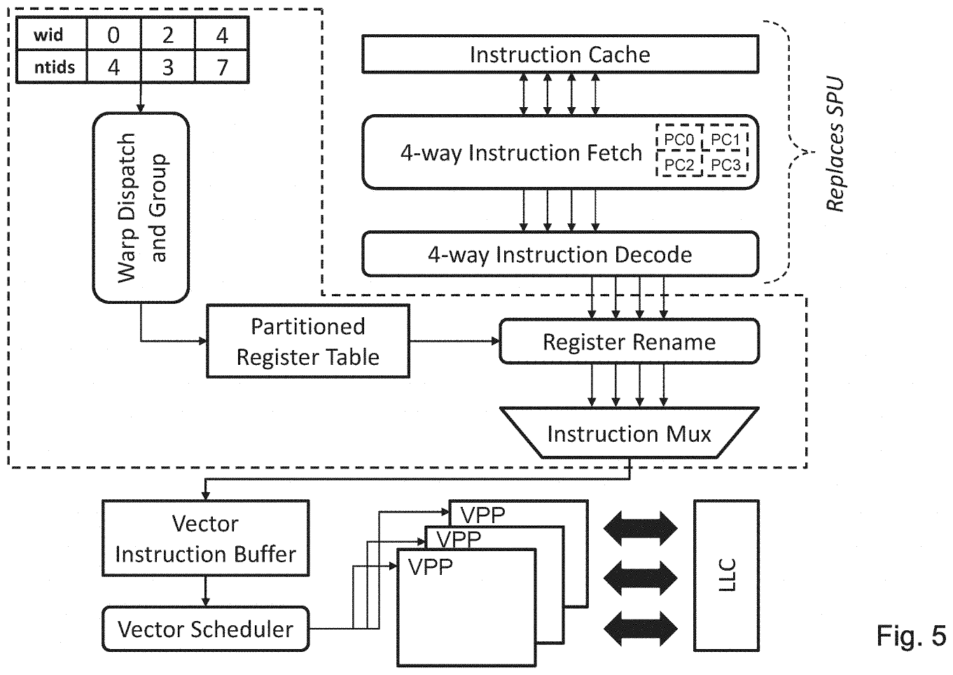

For a design in accordance with an embodiment of the invention, it is focused on the VPU and the instruction fetching capabilities of the SPU are used. FIG. 5 shows a schematic view illustrating an architecture overview of a vector core for a system in accordance with embodiments of the invention. A scheme for warp multiplexing by register renaming in accordance with an embodiment of the invention is integrated into SX-Aurora's vector core. Due to the focus on the offload mode, the SPU is removed except for its instruction fetch and decode units and the conventional register renaming unit is replaced by an embodiment as illustrated by FIG. 3 (cf. dotted box in FIG. 5).

FIG. 5 depicts modifications with regard to the architecture of FIG. 4 as follows: compared with the original VPU architecture (see FIG. 4), the register renaming unit is pulled before the vector instruction buffer (as illustrated by FIG. 5), since the OoO-execution is not used within partitions. Instead, vrPTX instructions are loaded for up to 4 partitions (using the SPU's 4-way instruction fetch) and multiplexed into a single vector instruction stream to the vector instruction buffer. The remainder (and majority) of the architecture can be maintained unchanged.

Thus, embodiments of the invention have the potential of improving the execution of irregular code for various throughput-oriented architectures. By implementing incremental changes that leave most of the existing architectures' overall designs intact, a comparatively cheap way can be offered to leverage existing systems for efficient irregular processing.

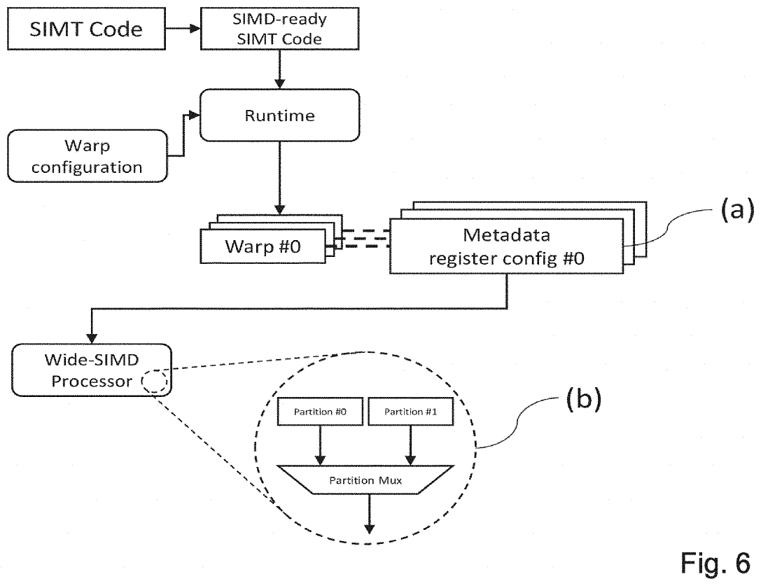

FIG. 6 shows a schematic view illustrating a method in accordance with an embodiment of the present invention. The embodiment outlined by FIG. 6 executes scalable SIMT-style code with different runtime configurations on SIMD processors using metadata registers that are programmed at runtime (cf. FIG. 6 (a)). Furthermore, several warps are dynamically packed with different configurations into the same SIMD registers such that they can be executed simultaneously through metadata concatenation (cf. FIG. 6 (b)). Both approaches are used to achieve irregular SIMT execution on a (wide-) SIMD processor.

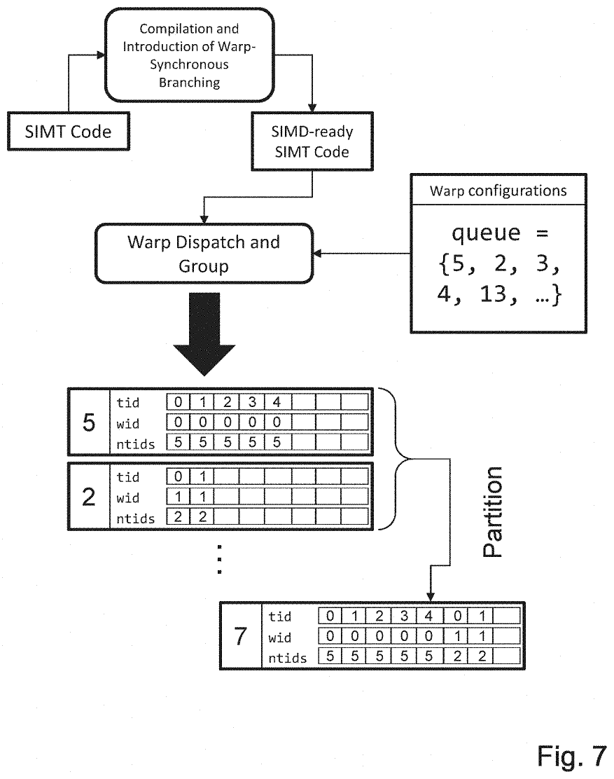

FIG. 7 shows a schematic view illustrating a process of metadata register programming for processing warps and partitioning of multiple warps into a single partition.

### Simulation Results of an Embodiment

An embodiment of the present invention extends CUDA's familiar programming model and implement SIMT-inspired strategies for dealing with data and control flow irregularities. The approach may require only minimal hardware changes and an additional compiler phase. It could be demonstrated using a model-based software simulation that the proposed system can be a step towards native support for irregularity on throughput-oriented processors while greatly simplifying the development of irregular applications.

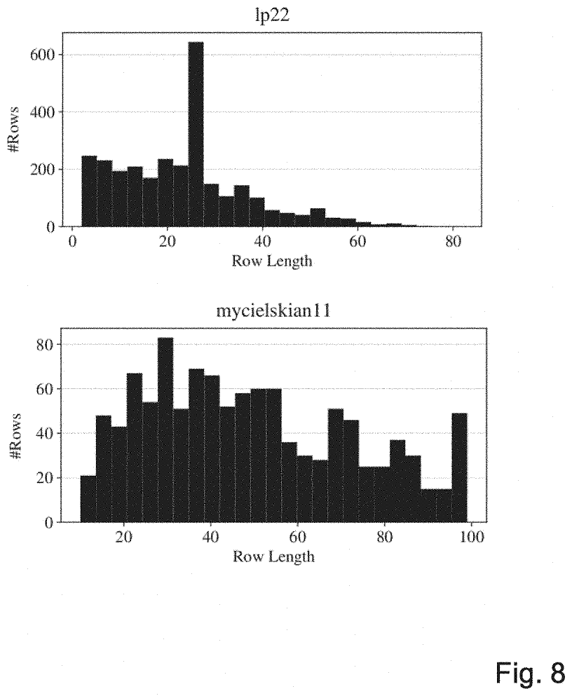

FIGS. 8, 9 and 10 shows results from a model-driven simulation of a setup in accordance with an embodiment of the invention, the setup running an SpMV kernel for two sparse matrices (upper row: lp22, lower row: mycielskian11) with one order of magnitude irregularity. The results show that the architecture modifications in accordance with an embodiment of the invention help to make efficient use of the execution units and hide latencies.

Due to a lack of details regarding NEC's SX-Aurora, the available ISA documentation was used in order to build a model following FIG. 4. Then it was simulated using the SimPy framework (cf. K. G. Müller and T; Vignaux; Simpy; retrievable at https://github.com/cristiklein/simpy). All latencies are expressed in terms of multiples of a simple arithmetic vector operation that takes 1 cycle, any complex resp. store operation's latency is the active vector length. One core of the vector processor was simulated with the same number of memory controllers and ports as Aurora. The simulation consumes the generated PTX from the SPMV example code (as illustrated by FIG. 1). Multiple matrices are inputted from the SuiteSparse Matrix Collection's linear programming category (cf. non-patent literature of T. A. Davis and Y. Hu.: “The University of Florida sparse matrix Collection”, ACM TOMS, 38:1-25, 2011), since these matrices often suffer from data irregularity (i.e. different row lengths). This test is meant to showcase two things: First, allowing more partitions (t—also the number of instruction fetch units) per core results in a larger vector instruction buffer which leads to better utilization of the execution units and thus less empty cycles. Second, packing can save instructions by batching warps—again, it is expected less time to termination.

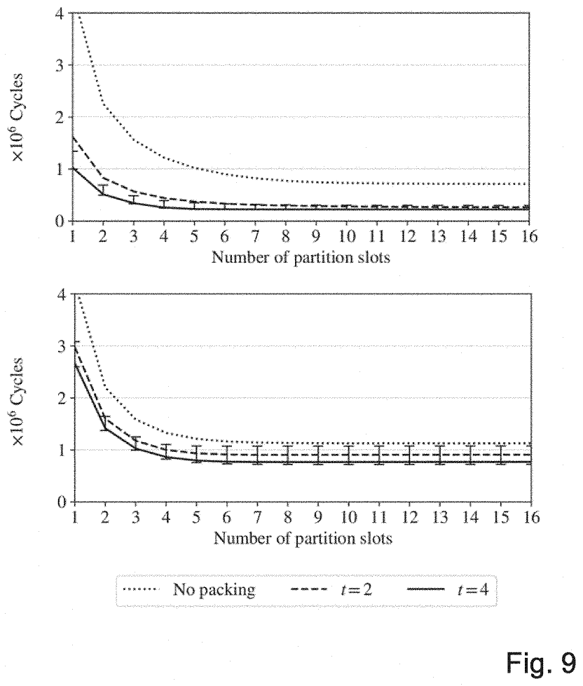

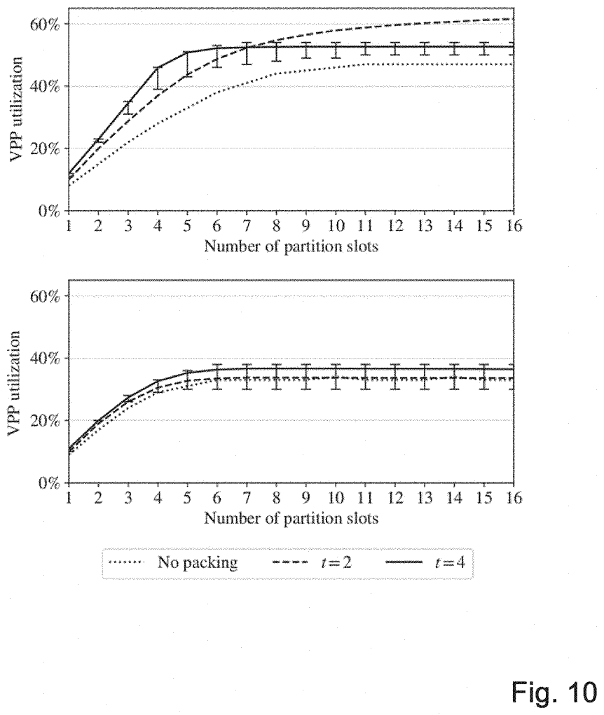

FIGS. 8-10 presents simulation results for two matrices that are representative for the test set: lp22 (2, 958×16, 392; 68, 512 nz—first row) and mycielskian11 (1, 535×1, 535; 134, 710 nz—second row). Their row length distributions, and thus warp size distributions, are visualized in FIG. 8. FIG. 9 supports a first hypothesis: Independent from the packing setup, more slots result in consistently less cycles being used. More slots lead to more and potentially different simultaneous instructions in the instruction buffer which in turn may be executed in parallel (pending execution unit availability). Furthermore, a looser threshold for packing (permitting higher warp size variations inside a partition) further reduces the total number of cycles spent. In FIG. 10, the execution unit utilization is visualized in the same experiments: Again, both more partitions as well as looser packing thresholds increase the utilization until reaching a plateau. Lastly, it is pointed to the error bars for t=4 (FIGS. 9, 10): for each parameter setting, the simulation was run 100 times, every time with a random order of the input matrix' rows, and the resulting error bars in both cycle and utilization plot are plotted. It is pointed out that although the variation is relatively large, at times negating the benefit of packing entirely, the average line (black) tends strongly towards the better region (lower cycles, higher utilization). This indicates that a smaller number of outliers is responsible for such failures. Since there is currently no support for work stealing or dynamic allocation, these outliers directly correspond to certain row orders.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for supporting throughput-oriented computing,
wherein a single instruction multiple threads program is configured to launch a plurality of warps,
wherein each respective warp of the plurality of warps comprises threads to be executed in lockstep within the each respective warp,
wherein individual warp sizes of the plurality of warps are used as a runtime parameter for the SIMT program, such that a parameterized SIMT program is provided, which is parameterizable via the individual warp sizes, and
wherein the parameterized SIMT program is executed on a single instruction multiple data vector architecture.

2. The method according to claim 1, wherein a programming model is provided, which is based on a SIMT programming model and which is extended for handling data irregularity by having a user input a list of warp sizes.

3. The method according to claim 1 or 2, wherein the plurality of warps are distributed to SIMD vector cores of the SIMD vector architecture.

4. The method according to claim 1, wherein the SIMT program is mapped onto SIMD vector registers of the SIMD vector architecture by using predetermined vector registers that are initialized by SIMT metadata of SIMT metadata registers.

5. The method according to claim 4, wherein the SIMT metadata includes a thread index information, a warp index information and/or a warp size information.

6. The method according to claim 1, wherein a mapping of the threads' SIMT metadata registers to lanes in SIMD vector registers of the SIMD vector architecture is performed at runtime.

7. The method according to claim 1, wherein the SIMT program is compiled to an intermediate code representation, wherein the intermediate code representation is configured to replace one or more identifiers pertaining to a runtime configuration of the SIMT program with references to SIMT metadata registers.

8. The method according to claim 7, wherein the intermediate code representation includes a scalar branch control such that warp-synchronous branching commands are provided that only branch based on all threads in the warp agreeing on a predicate's result.

9. The method according to claim 8, wherein the predicate is created whenever branching is involved in the SIMT program, wherein the predicate indicates whether a thread took a branch or not, and wherein the predicate's result is applied to all instructions that can follow.

10. The method according to claim 1, wherein a control flow of the SIMT program is modified to emulate branching by using a stack of masks for SIMD vector registers, wherein a translation from thread-wide branching instructions to warp-wide branching instructions is provided.

11. The method according to claim 1, wherein a partitioning scheme is implemented for executing partitions on a SIMD vector core of the SIMD vector architecture, wherein a partition includes one or more warps to be executed on the SIMD vector core.

12. The method according to claim 11, wherein at least some of the warps included in the partition are packed into a SIMD vector register by concatenating metadata of the at least some of the warps, and wherein a vector length of the -SIMD vector register is increased accordingly.

13. The method according to claim 1, wherein a register renaming is performed inside SIMD vector cores in order to multiplex instruction streams from multiple partitions into a vector instruction buffer.

14. The method according to claim 13, wherein the register renaming is performed based on a partitioned register table.

15. A system for supporting throughput-oriented computing, the system comprising:
a programming model and a single instruction multiple data (SIMD) vector architecture, wherein the programming model is configured to:
provide a single instruction multiple threads (SIMT) program for launching a plurality of warps, wherein each respective warp of the plurality of warps comprises threads to be executed in lockstep within the each respective warp, and
use individual warp sizes of the plurality of warps as a runtime parameter for the SIMT program, such that a parameterized SIMT program is provided, which is parameterizable via the individual warp sizes, and
wherein the SIMD vector architecture is configured to execute the parameterized SIMT program.

16. The method according to claim 1, wherein the throughput-oriented computing includes a high-performance computing system.

17. The method according to claim 3, wherein the plurality of warps are distributed to the SIMD vector cores using a round-robin method.
